(19) United States
(12) Patent Application Publication
(10) Pub. No.: US 2020/0301748 A1
(43) Pub. Date: Sep. 24, 2020

(54) APPARATUSES AND METHODS FOR SMART LOAD BALANCING IN A DISTRIBUTED COMPUTING SYSTEM

(71) Applicant: Nutanix, Inc., San Jose, CA (US)

(72) Inventors: ANKUR GUPTA, BENGALURU (IN); NITIN JAIN, BANGALORE (IN); MANISH KUMAR, BANGALORE (IN); UDAY BHASKAR, BANGALORE (IN)

(73) Assignee: Nutanix, Inc., San Jose, CA (US)

(21) Appl. No.: 16/357,070

(22) Filed: Mar. 18, 2019

(51) Int. Cl. G06F 9/50; G06F 16/245; G06F 16/27

(52) U.S. Cl. CPC G06F 9/5083; G06F 2209/505; G06F 16/27; G06F 16/245

(57) ABSTRACT

Examples of load balancing across multiple computing nodes of distributed computing systems is described herein. Examples include determining whether an application request is part of a first application request set or a second application request set, and routing the application request to a first computing node or a second computing node of a computing node cluster based on the determination. Other examples include determining whether a database operation request directed to a database is part of a first database operation set or a second database operation set, and routing the database operation request to a first server using a first instance of the database or a second server using a second instance of the database based on the determination. Routing the application and database operation requests based on criteria of the respective request may improve execution efficiency of the requests.

### TECHNICAL FIELD

Examples described herein relate generally to distributed computing systems. Examples of virtualized systems are described. Examples of load balancing across multiple computing nodes of distributed computing systems is described herein.

### BACKGROUND

As distributed computing systems and virtualized computing environments become more prevalent, traffic and resource inefficiencies can arise related to handling received instructions, requests, database queries, etc. For example, routing of a received instruction, request, database query, etc., to a particular computing node for execution may be based on resource availability of the particular computing node with no consideration given to the details associated with the received instruction, request, database query, etc. Because instructions, requests, database queries, etc., that are similar may use common data/instruction sets, this type of routing schema may result in inefficient use of computing resources to execute similar types of received instructions, requests, database queries, etc., when routed to different computing nodes, such as having to repeat loading of common data/instruction sets into cache in order to address the instruction, request, database query, etc.

### BRIEF DESCRIPTION OF THE DRAWINGS

FIG. 1 is a block diagram of a computing system, in accordance with an embodiment of the present disclosure.

FIG. 2 is a flow diagram of a computing system, in accordance with an embodiment of the present disclosure.

FIG. 3 is a block diagram of a distributed computing system, in accordance with an embodiment of the present disclosure.

FIG. 4 is a flow diagram illustrating a method for routing database operation requests, in accordance with an embodiment of the present disclosure.

FIG. 5 is a flow diagram illustrating a method for routing application requests in accordance with an embodiment of the present disclosure.

FIG. 6 depicts a block diagram of components of a computing node in accordance with an embodiment of the present disclosure.

### DETAILED DESCRIPTION

This disclosure describes embodiments for routing of received application requests and/or database operations based on details associated with the application requests or the database operations, respectively. For example, a distributed computing system may receive an application request directed to an application hosted on computing nodes of a computing node cluster. Each of the computing nodes may be configured to host several applications, including the application identified by the application request. The application request may be initially received at an application balancer. The application balancer may include a service or application hosted on another computing node outside the computing node cluster or a service or application hosted on one of the computing nodes of the computing node cluster. The application balancer may be configured to divide application requests into request sets, which are used to determine allocation of received application requests. Each request set may include all application requests for a single application of the several applications hosted on the computing nodes; a subset of application requests for a single application of the several applications hosted on the computing nodes, with other applications requests associated with the single application divided among one or more other request sets; a subset of some or all requests for more than one of the several applications hosted on the computing nodes; or any combination thereof. The request sets may be constructed based on a target application, a request type (e.g., read, write, etc.), frequency relative to other application requests, resource consumption, etc. In response to receipt of the application request, the application balancer may determine the request set to which the application request belongs, and route the application request to the computing node that is assigned to the determined request set. Thus, if the application balancer determines the application request is part of a first application request set, it routes the application request to a first computing node of the computing nodes; and if the application balancer determines the application request is part of a second application request set, it routes the application request to a second computing node of the computing nodes. By allocating similar application requests to the same computing node, a reduction in repeated loading of cache with data and instruction sets to execute the application request may be realized as compared with systems that route based on geography or resource availability without considering details of the request.

In another example, the distributed computing system may receive a database operation request directed to a target database. Instances of the target database may be loaded on several computing nodes of a cluster. The database operation request may be initially received at database balancer. The database balancer may include a service or application hosted on another computing node outside the computing node cluster or a service or application hosted on one of the computing nodes of the computing node cluster. The database balancer may be configured to divide database operation requests into operation type sets, which are used to determine allocation of received database operation requests. Each operation type set may include all database operations for a single operation type; one database operation type directed to a subset of the database data, with the one data operation type directed to other portions of the data of the database divided among one or more other operation type sets; a subset of some or all operation types; or any combination thereof. The operation type sets may be defined based on targeted data, an operation type, frequency relative to other operation types, resource consumption, etc. In response to receipt of the database operation request, the database balancer may determine the operation type set to which the database operation request belongs, and route the database operation request to the computing node that is assigned to the determined operation type set. Thus, if the database balancer determines the database operation request is part of a first operation type set, it routes the database operation request to a first computing node of the computing nodes; and if the database balancer determines the database operation request is part of a second operation type set, it routes the database operation request to a second computing node of the computing nodes. By allocating similar database operation requests to the same computing node, a reduction in repeated loading of cache with data tables and indexes to execute the database operation requests may be realized as compared with systems that route based on geography or resource availability without considering details of the request.

Various embodiments of the present disclosure will be explained below in detail with reference to the accompanying drawings. The detailed description includes sufficient detail to enable those skilled in the art to practice the embodiments of the disclosure. Other embodiments may be utilized, and structural, logical and electrical changes may be made without departing from the scope of the present disclosure. The various embodiments disclosed herein are not necessary mutually exclusive, as some disclosed embodiments can be combined with one or more other disclosed embodiments to form new embodiments.

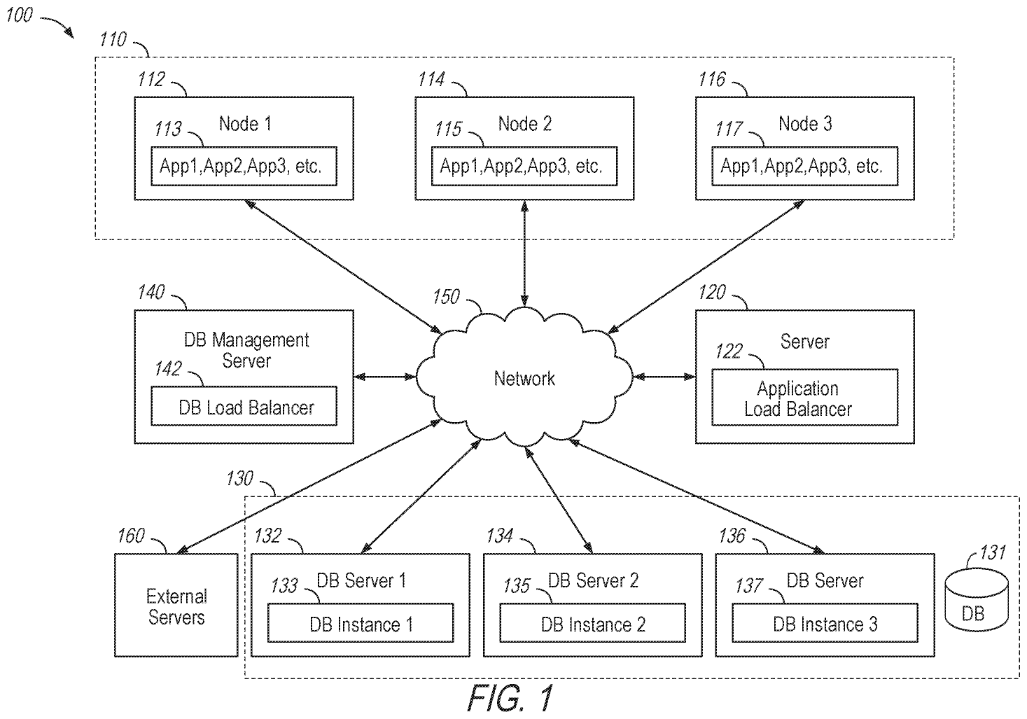

FIG. 1 is a block diagram of a computing system 100, in accordance with an embodiment of the present disclosure. The computing system 100 may include some or all of a computing node cluster 110, a server 120, a server 132, a server 140, and external servers 160 connected together via a network 150. The network 150 may include any type of network capable of routing data transmissions from one network device (e.g., the computing node cluster 110, the server 120, the database management system 130, the server 140, and/or the external servers 160) to another. For example, the network 150 may include a local area network (LAN), wide area network (WAN), intranet, or a combination thereof. The network 150 may be a wired network, a wireless network, or a combination thereof.

The computing node cluster 110 may include a computing node 112, a computing node 114, and a computing node 116 configured to service application requests. Each of the computing node 112, the computing node 114, and/or the computing node 116 may include, for example, a server computer, a laptop computer, a desktop computer, a tablet computer, a smart phone, or any other type of computing device. More or fewer than three computing nodes may be included in the computing node cluster 110 without departing from the scope of the disclosure. Each of the computing node 112, the computing node 114, and/or the computing node 116 include software and firmware, support permissions, contracts, assigned policies, and update procedures specific to the application. Thus, each of the computing node 112, the computing node 114, and/or the computing node 116 may be configured to host respective applications 113, applications 115, and applications 117. The computing node 112, the computing node 114, and/or the computing node 116 may work together within the computing node cluster 110 to perform a function, such as a distributed file server, a backup system, etc. In some examples, the applications 113, the applications 115, and the applications 117 may include at least some common applications and/or services. Each of the computing node 112, the computing node 114, and/or the computing node 116 may receive application requests directed to the applications 113, the applications 115, and the applications 117, respectively, and the computing node 112, the computing node 114, and/or the computing node 116 may execute the application requests in response to receipt.

The server 120 may include, for example, a server computer, a laptop computer, a desktop computer, a tablet computer, a smart phone, or any other type of computing device. The server 120 may be configured to host an application load balancer 122. The application load balancer 122 may be a service or a standalone application hosted on the server 120. The application load balancer 122 may receive application requests directed to an application hosted on at least one of the computing node 112, the computing node 114, and/or the computing node 116, and route the application request to a specific one of the computing node 112, the computing node 114, and/or the computing node 116. To determine routing of application requests, the application load balancer 122 may divide application requests into request sets based on various criteria, such as the target application, a request type, a frequency of a particular request relative to other requests, resource impact associated with a particular request type relative to other request types, or any combination thereof. The application load balancer 122 may associate a request set with a specific one of the computing node 112, the computing node 114, and/or the computing node 116, and may route application requests based on this association. The request set to computing node allocation may update based on resource impact, computing node availability/failure, etc. in addition, the request sets may be dynamically adjusted in response to changes in a frequency of a particular request relative to other requests, a resource impact associated with a particular request type relative to other request types, additional resource availability of a particular computing node, etc.

The database management system 130 may include a server 132, a server 134, and a server 136 configured to service database operation requests associated with a database 131. Each of the server 132, the server 134, and/or the server 136 may include, for example, a server computer, a laptop computer, a desktop computer, a tablet computer, a smart phone, or any other type of computing device. More or fewer than three database servers may be included in the database management system 130 without departing from the scope of the disclosure. Each of the server 132, the server 134, and/or the server 136 may be configured service database operation requests to the database 131 by loading a first database instance 133, a second database instance 135, and a third database instance 137, respectively, based on the database 131. The first database instance 133, the second database instance 135, and the third database instance 137 may be independently accessible such that they are able to execute access operations in parallel. Each of the server 132, the server 134, and/or the server 136 include software and firmware, support permissions, contracts, assigned policies, and update procedures specific to the managing the first database instance 133, the second database instance 135, and the third database instance 137, respectively. Each of the server 132, the server 134, and/or the server 136 may receive respective database operation requests directed to the first database instance 133, the second database instance 135, and the third database instance 137, respectively, and the server 132, the server 134, and/or the server 136 may execute the database operation requests in response to receipt.

The server 140 may include, for example, a server computer, a laptop computer, a desktop computer, a tablet computer, a smart phone, or any other type of computing device. The server 140 may be configured to host a database load balancer 142. The database load balancer 142 may be a service or a standalone application hosted on the server 140. The database load balancer 142 may receive database operation requests directed to the common database represented by each of the first database instance 133, the second database instance 135, and the third database instance 137. In response to receipt of the database operation request, the database load balancer 142 may route the database operation request to a specific one of the server 132, the server 134, and/or the server 136. To determine routing of the database operation requests, the database load balancer 142 may divide database operation requests into operation type sets based on various criteria, such as target data, an operation type, a frequency of a particular operation relative to other operations, resource impact associated with a particular operation type relative to other operation types, or any combination thereof. The database load balancer 142 may associate an operation type set with a specific one of the server 132, the server 134, and/or the server 136, and may route database operation requests based on this association. The operation type set to database server allocation may update based on resource impact, database server availability/failure, etc. In addition, the operation type sets may be dynamically adjusted in response to changes in a frequency of a particular operation relative to other operations, a resource impact associated with a particular operation type relative to other operation types, additional resource availability of a particular database server, etc.

In operation, the distributed computing system 100 may include the server 120 hosted the application load balancer 122 to balance application requests across the computing node cluster 110 and/or the server 140 hosted the database load balancer 142 to balance database operation requests across the database management system 130. For example, the application load balancer 122 may receive an application request directed to an application included in one or more of the applications 113, the applications 115, and the applications 117 hosted on the computing node 112, the computing node 114, and the computing node 116, respectively, of the computing node cluster 110, and may route the application request to one of the computing node 112, the computing node 114, or the computing node 116. Application requests may be received from one of the computing node 112, the computing node 114, or the computing node 116, and/or the external servers 160. Generally, executing an application request involves executing a set of instructions corresponding to the request to retrieve, change, store, etc., associated data. To make this process more efficient, the instruction set and data to execute the request may be loaded into a cache for temporary storage. In many processing systems, performing operations using instructions and data stored in a cache is more efficient as compared with having to first retrieve data from external memory. In addition, a subsequent application request that implicates an instruction set and/or data that is already stored in the cache may be executed more efficiently, as an initial step of retrieving the instruction set and/or data from memory may be skipped. Thus, repeated servicing of common or similar application requests may be more efficient as compared with servicing different application requests.

The application load balancer 122 may be configured to route received application requests among the computing node 112, the computing node 114, or the computing node 116 of the computing node cluster 110 to leverage this similar request efficiency. Thus, to determine application request routing, the application load balancer 122 may be configured to divide application requests into defined request sets. Each request set may be defined to include all application requests for a single application; a subset of application requests for a single application; a subset of some or all requests for more than one application; or any combination thereof. The request sets may be defined based on details of the application requests (e.g., a target application, a request type (e.g., read, write, etc.), frequency relative to other application requests, resource impact, etc.), relative resource availability of the computing node 112, the computing node 114, and the computing node 116, or combinations thereof. The request sets may be dynamically adjusted or re-defined based on resource availability, relative application request type frequency, or other environmental conditions. In response to receipt of the application request, the application load balancer 122 may determine the request set to which the application request belongs, and route the application request to the one of the computing node 112, the computing node 114, and the computing node 116 that is associated with the determined request set. Thus, if the application load balancer 122 determines the application request is part of a first request set, the application load balancer 122 routes the application request to the computing node 112; if the application load balancer 122 determines the application request is part of a second request set, the application load balancer 122 routes the application request to the computing node 114, and if the application load balancer 122 determines the application request is part of a third request set, the application load balancer 122 routes the application request to the computing node 116. The one of the computing node 112, the computing node 114, and the computing node 116 to which the application request is routed may be configured to execute the application request via one a target application of the applications 113, the applications 115, or the applications 117, respectively. By allocating similar application requests to a same computing node, a reduction in repeated loading of cache with data and instruction sets from memory to execute the application request may be realized as compared with systems that route based on geography or resource availability without considering details of the request.

In another example, the database load balancer 142 may receive a database operation request directed to the database 131, and may route the database operation request to one of the server 132, the server 134, or the server 136. Generally, executing a database operation may involve generating indexes and/or tables corresponding to data in a database in order to locate all data pertaining to the requested operation. Generation of database indexes and tables may be a time-consuming step; especially with large databases. To make this process more efficient, the generated indexes and/or tables may be loaded into a cache for temporary storage. In many processing systems, performing operations using indexes and/or tables stored that is stored in a cache is more efficient as compared with having to first generate the indexes and tables. In addition, a subsequent database operation that implicates the generated indexes and tables already stored in the cache may be executed more efficiently, as an initial step of generating the indexes and tables may be skipped. Thus, repeated servicing of common or similar database operations may be more efficient as compared with servicing different database operations.

The database load balancer 142 may be configured to route received database operation requests among the server 132, the server 134, or the server 136 of the database management system 130 to leverage this similar operation efficiency. To determine database operation request routing, the database load balancer 142 may be configured to divide database operation requests into defined operation type sets. Each operation type set may be defined to include all database operations for a single operation type; one database operation type directed to a subset of the database data, with the one data operation type directed to other portions of the data of the database divided among one or more other operation type sets; a subset of some or all operation types; or any combination thereof. The operation type sets may be defined based on targeted data, an operation type (e.g., type of query, update to the database, etc.), frequency relative to other operation types, resource consumption associated with an operation type, etc. The operation type sets may be dynamically adjusted or re-defined based on resource availability, relative operation type frequency, or other environmental conditions. In response to receipt of the database operation request, the database load balancer 142 may determine the operation type set to which the database operation request belongs, and route the database operation request to the one of the server 132, the server 134, or the server 136 that is assigned to the determined operation type set. Thus, if the database load balancer 142 determines the database operation request is part of a first operation type set, the database load balancer 142 may route the database operation request to the server 132; if the database load balancer 142 determines the database operation request is part of a second operation type set, the database load balancer 142 may route the database operation request to the server 134, and if the database load balancer 142 determines the database operation request is part of a third operation type set, the database load balancer 142 may route the database operation request to the server 136. The one of the server 132, the server 134, and the server 136 to which the database operation request is routed may be configured to execute the operation. By allocating similar database operation requests to the same computing node, a reduction in repeated generating and loading of cache with data tables and indexes to execute the database operation requests may be realized as compared with systems that route based on geography or resource availability without considering details of the request.

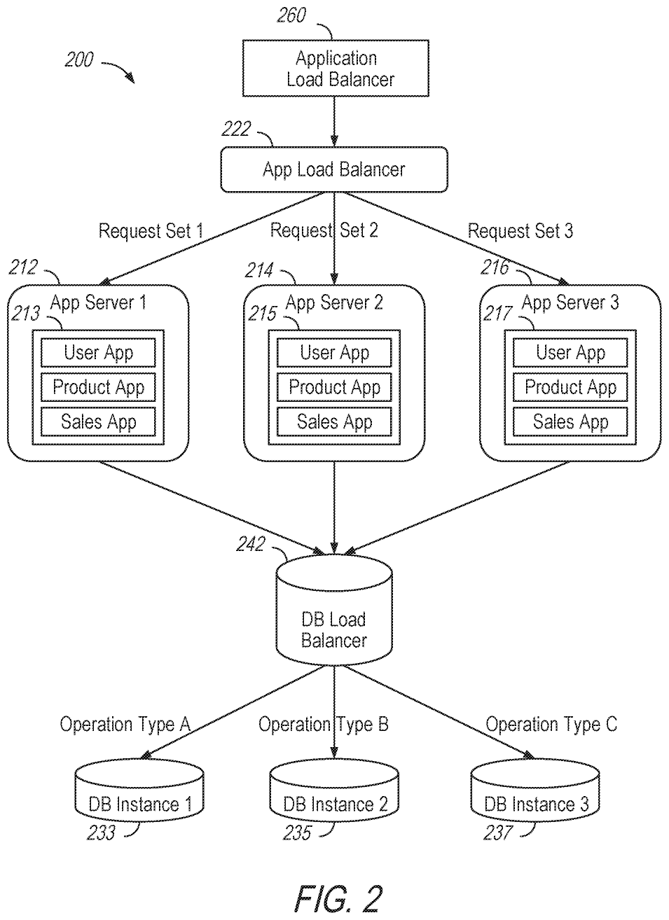

FIG. 2 is a flow diagram 200 of a computing system, in accordance with an embodiment of the present disclosure. The flow diagram 200 may provide an example of operation of the computing system 100 of FIG. 1. The 200 may include some or all of a application load balancer 222, a computing node 212, a computing node 214, a computing node 216, a database load balancer 242, a first database instance 233, a second database instance 235, a third database instance 237, and a database load balancer 242. One or more of the application load balancer 222, the computing node 212, the computing node 214, the computing node 216, the database load balancer 242, the first database instance 233, the second database instance 235, and the third database instance 237 may be implemented in one or more of the application load balancer 122, the computing node 112, the computing node 114, the computing node 116, the database load balancer 142, the first database instance 133, the second database instance 135, and the third database instance 137, respectively, of FIG. 1, in some examples.

In operation, the application load balancer 222 may receive an application request directed to an application (e.g., a user application, a product application, a sales application, etc.) included in one or more of the applications 213, the applications 215, and the applications 217 hosted on the computing node 212, the computing node 214, and the computing node 216, respectively. The application load balancer 222 may be configured to route the application request to one of the computing node 212, the computing node 214, or the computing node 216 based on characteristics and details associated with the application request. Executing the application request may involve loading and executing a set of instructions corresponding to the request to retrieve, change, store, etc., associated data. Thus, the application load balancer 222 may be configured to route similar received application requests to a common one of the computing node 212 the computing node 214, or the computing node 216 to mitigate repeated loading of an instruction set from memory. To determine application request routing, the application load balancer 222 may be configured to divide application requests into defined request sets, with each request set defined to include all application requests for a single application; a subset of application requests for a single application; a subset of some or all requests for more than one application; or any combination thereof. The request sets may be defined based on a target application, a request type (e.g., read, write, etc.), frequency relative to other application requests, resource impact, etc., as well as relative resource availability of the computing node 212, the computing node 214, and the computing node 216. In response to receipt of the application request, the application load balancer 222 may determine the request set to which the application request belongs, and route the application request to the one of the computing node 212, the computing node 214, and the computing node 216 that is associated with the determined request set. Thus, if the application load balancer 222 determines the application request is part of a first request set (e.g., request set 1), the application load balancer 222 routes the application request to the computing node 212; if the application load balancer 222 determines the application request is part of a second request set (e.g., request set 2), the application load balancer 222. routes the application request to the computing node 214, and if the application load balancer 222 determines the application request is part of a third request set (e.g., request set 3), the application load balancer 222 routes the application request to the computing node 216. The one of the application load balancer 222, the 224, and the 226 to which the application request is routed may be configured to execute the application request via one a target application of the applications 213, the applications 215, or the applications 217, respectively. By allocating similar application requests to a same computing node, a reduction in repeated loading of cache with data and instruction sets from memory to execute the application request may be realized as compared with systems that route based on geography or resource availability without considering details of the request.

The database load balancer 242 may receive a database operation requests directed to a target database from the computing node 212, the computing node 214, and/or the computing node 216. In some examples, the database operation requests may be based on or in response to application requests being executed by the computing node 212, the computing node 214, and/or the computing node 216. The database load balancer 242 route the database operation request to be serviced using one of the first database instance 233, the second database instance 235, or the third database instance 237. Executing a database operation may involve generating indexes and/or tables corresponding to data in a database in order to locate all data pertaining to the requested operation. The database load balancer 242 may be configured to route received database operation requests to be serviced using one of a first database instance 233, a second database instance 235, and a third database instance 237 in order to leverage generated indexes and tables from previous database operations. Thus, the database load balancer 242 may be configured to divide database operation requests into defined operation type sets. Each operation type set may be defined to include all database operations for a single operation type; one database operation type directed to a subset of the database data, with the one data operation type directed to other portions of the data of the database divided among one or more other operation type sets; a subset of some or all operation types; or any combination thereof. The operation type sets may be defined based on targeted data, an operation type, frequency relative to other operation types, resource consumption associated with an operation type, etc. In response to receipt of the database operation request, the database load balancer 242 may determine the operation type set to which the database operation request belongs, and route the database operation request to be serviced using one of the first database instance 233, the second database instance 235, or the third database instance 237 assigned to the determined operation type set. Thus, if the database load balancer 242 determines the database operation request is part of a first operation type set (e.g., Operation Type A), the database load balancer 242 may route the database operation request to be serviced by the first database instance 233; if the database load balancer 242 determines the database operation request is part of a second operation type set (e.g., Operation Type B), the database load balancer 242 may route the database operation request to be serviced by the second database instance 235, and if the database load balancer 242 determines the database operation request is part of a third operation type set (e.g., Operation Type C), the database load balancer 242 may route the database operation request to be serviced by the third database instance 237. The one of the first database instance 233, the second database instance 235, and the third database instance 237 to which the database operation request is routed may be configured to service the requested operation. By allocating similar database operation requests to the same computing node, a reduction in repeated generating and loading of cache with data tables and indexes to execute the database operation requests may be realized as compared with systems that route based on geography or resource availability without considering details of the request. In some examples, the application load balancer 222 and/or the database load balancer 242 may be included in one or more of the computing node 212, the computing node 214, and/or the computing node 216 without departing from the scope of the disclosure.

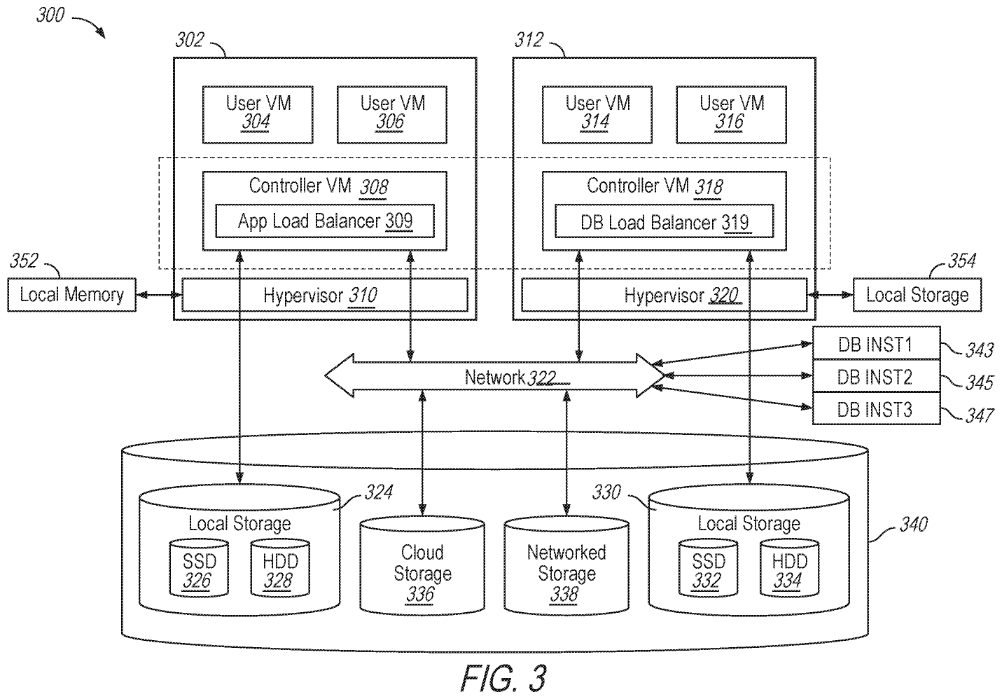

FIG. 3 is a block diagram of a distributed computing system 300, in accordance with an embodiment of the present disclosure. The distributed computing system 300 generally includes computing node 302 and computing node 312. and storage 340 connected to a network 322. More computing nodes may be included in the distributed computing system 300 without departing from the scope of the disclosure. The network 322 may be any type of network capable of routing data transmissions from one network device (e.g., computing node 302, computing node 312, and storage 340) to another. For example, the network 322 may be a local area network (LAN), wide area network (WAN), intranet, Internet, or a combination thereof. The network 322 may be a wired network, a wireless network, or a combination thereof. The distributed computing system 300 may be implemented in the 100 of FIG. 1, in some examples. The distributed computing system 300 may be configured to implement at least part of the flow diagram 200 of FIG. 2, in some examples.

The storage 340 may include local storage 324, local storage 330, cloud storage 336, and networked storage 338. The local storage 324 may include, for example, one or more solid state drives (SSD 326) and one or more hard disk drives (HUD 328). Similarly, local storage 330 may include SSD 332 and HDD 334. Local storage 324 and local storage 330 may be directly coupled to, included in, and/or accessible by a respective computing node 302 and/or computing node 312 without communicating via the network 322. Cloud storage 336 may include one or more storage servers that may be stored remotely to the computing node 302 and/or computing node 312 and accessed via the network 322. The cloud storage 336 may generally include any type of storage device, such as HDDs SSDs, or optical drives. Networked storage 338 may include one or more storage devices coupled to and accessed via the network 322. The networked storage 338 may generally include any type of storage device, such as HDDs SSDs, or optical drives. In various embodiments, the networked storage 338 may be a storage area network (SAN).The computing node 302 is a computing device for hosting VMs in the distributed computing system of FIG. 3. The computing node 302 may be, for example, a server computer, a laptop computer, a desktop computer, a tablet computer, a smart phone, or any other type of computing device. The computing node 302 may include one or more physical computing components, such as processors.

The computing node 302 is configured to execute a hypervisor 310, a controller VM 308 and one or more user VMs, such as user VMs 304, 306. The user VMs including user VM 304 and user VM 306 are virtual machine instances executing on the computing node 302. The user VMs including user VM 304 and user VM 306 may share a virtualized pool of physical computing resources such as physical processors and storage (e.g., storage 340). The user VMs including user VM 304 and user VM 306 may each have their own operating system, such as Windows or Linux. While a certain number of user VMs are shown, generally any number may be implemented. User VMs may generally be provided to execute any number of applications which may be desired by a user.

The hypervisor 310 may be any type of hypervisor. For example, the hypervisor 310 may be ESX, ESX(i), Hyper-V, KVM, or any other type of hypervisor. The hypervisor 310 manages the allocation of physical resources (such as storage 340 and physical processors) to VMs (e.g., user VM 304, user VM 306, and controller VM 308) and performs various VM related operations, such as creating new VMs and cloning existing VMs. Each type of hypervisor may have a hypervisor-specific API through which commands to perform various operations may be communicated to the particular type of hypervisor. The commands may be formatted in a manner specified by the hypervisor-specific API for that type of hypervisor. For example, commands may utilize a syntax and/or attributes specified by the hypervisor-specific API.

Controller VMs (CVMs) described herein, such as the controller VM 308 and/or controller VM 318, may provide services for the user VMs in the computing node. As an example of functionality that a controller VM may provide, the controller VM 308 may provide virtualization of the storage 340. Controller VMs may provide management of the distributed computing system shown in FIG. 3. Examples of controller VMs may execute a variety of software and/or may serve the I/O operations for the hypervisor and VMs running on that node. In some examples, a SCSI controller, which may manage SSI) and/or HDD devices described herein, may be directly passed to the CVM, e.g., leveraging VM-Direct Path. In the case of Hyper-V, the storage devices may be passed through to the CVM.

The computing node 312 may include user VM 314, user VM 316, a controller VM 318, and a hypervisor 320. The user VM 314, user VM 316, the controller VM 318, and the hypervisor 320 may be implemented similarly to analogous components described above with respect to the computing node 302. For example, the user VM 314 and user VIVI 316 may be implemented as described above with respect to the user VM 304 and user VM 306, The controller VM 318 may be implemented as described above with respect to controller VM 308. The hypervisor 320 may be implemented as described above with respect to the hypervisor 310. In the embodiment of FIG. 3, the hypervisor 320 may be a different type of hypervisor than the hypervisor 310. For example, the hypervisor 320 may be Hyper-V, while the hypervisor 310 may be ESX(i).

The controller VM 308 and controller VM 318 may communicate with one another via the network 322. By linking the controller VIVI 308 and controller VM 318 together via the network 322, a distributed network of computing nodes including computing node 302 and computing node 312, can be created.

Controller VMs, such as controller VM 308 and controller VM 318, may each execute a variety of services and may coordinate, for example, through communication over network 322. Services running on controller VMs may utilize an amount of local memory to support their operations. For example, services running on controller VM 308 may utilize memory in local memory 352. Services running on controller VM 318 may utilize memory in local memory 354. The local memory 352 and local memory 354 may be shared by VMs on computing node 302 and computing node 312, respectively, and the use of local memory 352 and/or local memory 354 may be controlled by hypervisor 310 and hypervisor 320, respectively. Moreover, multiple instances of the same service may be running throughout the distributed system—e.g. a same services stack may be operating on each controller VM. For example, an instance of a service may be running on controller VM 308 and a second instance of the service may be running on controller VM 318.

Generally, controller VMs described herein, such as controller VM 308 and controller VM 318 may be employed to control and manage any type of storage device, including all those shown in storage 340 of FIG. 3, including local storage 324 (e.g., SSD 326 and HDD 328), cloud storage 336, and networked storage 338. Controller VMs described herein may implement storage controller logic and may virtualize all storage hardware as one global resource pool (e.g., storage 340) that may provide reliability, availability, and performance. IP-based requests are generally used (e.g., by user VMs described herein) to send I/O requests to the controller VMs. For example, user VM 304 and user VM 306 may send storage requests to controller VM 308 using an IP request. Controller VMs described herein, such as controller VM 308, may directly implement storage and I/O optimizations within the direct data access path.

In some examples, the controller VM 308 may include an application load balancer 309 that facilitates routing of application requests among the computing nodes 302, 312. In some examples, the application requests may be provided by and/or may be directed to one or more of the user VMs 304, 306, 314, and 316. That is, the application load balancer 309 may receive an application request directed to an application (e.g., a user application, a product application, a sales application, etc.) included in one or more of the computing nodes 302, 312, and may route the application request to one of the computing nodes 302, 312 based on characteristics and details associated with the application request. Executing the application request may involve loading and executing a set of instructions corresponding to the request to retrieve, change, store, etc., associated data. Thus, the application load balancer 309 may be configured to route similar received application requests to a common one of the computing nodes 302, 312 to mitigate repeated loading of an instruction set from memory. To determine application request routing, the application load balancer 309 may be configured to divide application requests into defined request sets, with each request set defined to include all application requests for a single application; a subset of application requests for a single application; a subset of some or all requests for more than one application; or any combination thereof. The request sets may be defined based on a target application, a request type (e.g., read, write, etc.), frequency relative to other application requests, resource impact, etc., as well as relative resource availability of the computing nodes 302, 312. In response to receipt of the application request, the application load balancer 309 may determine the request set to which the application request belongs, and route the application request to the one of the computing nodes 302, 312. that is associated with the determined request set. The one of the computing nodes 302, 312 to which the application request is routed may be configured to execute the application request via an instruction set of a target application. By allocating similar application requests to a same computing node, a reduction in repeated loading of cache with data and instruction sets from memory to execute the application request may be realized as compared with systems that route based on geography or resource availability without considering details of the request.

In some examples, the controller VM database load balancer 319 may include a database load balancer 319 that facilitates routing of database operation requests to be serviced using one of a first database instance 343, a second database instance 345, and a third database instance 347 accessible to the computing nodes 302, 312 via the network 322. In some examples, the database operation requests may be provided by one or more of the user VMs 304, 306, 314, and 316. In some examples, the database operation requests may be based on or in response to application requests being executed by the computing nodes 302, 312. Executing a database operation may involve generating indexes and/or tables corresponding to data in a database in order to locate all data pertaining to the requested operation. The database load balancer 319 may be configured to route received database operation requests to be serviced using one of the first database instance 343, the second database instance 345, and the third database instance 347 in order to leverage generated indexes and tables from previous database operations. Thus, the database load balancer 319 may be configured to divide database operation requests into defined operation type sets, with operation type set defined to include all database operations for a single operation type; one database operation type directed to a subset of the database data, with the one data operation type directed to other portions of the data of the database divided among one or more other operation type sets; a subset of some or all operation types; or any combination thereof. The operation type sets may be defined based on targeted data, an operation type, frequency relative to other operation types, resource consumption associated with an operation type, etc. In response to receipt of the database operation request, the database load balancer 319 may determine the operation type set to which the database operation request belongs, and route the database operation request to be serviced using one of the first database instance 343, the second database instance 345, and the third database instance 347 assigned to the determined operation type set. The one of first database instance 343, the second database instance 345, and the third database instance 347 to which the database operation request is routed may be configured to service the requested operation. By allocating similar database operation requests to the same computing node, a reduction in repeated generating and loading of cache with data tables and indexes to execute the database operation requests may be realized as compared with systems that route based on geography or resource availability without considering details of the request.

In some examples, an instance of the application load balancer 309 and/or the database load balancer 319 may be included on both of the computing nodes 302, 312 without departing from the scope of the disclosure. In some examples, the application load balancer 309 and/or the database load balancer 319 may be instead included on an external computing node. In some examples, the first database instance 343, the second database instance 345, and the third database instance 347 and/or the source database may be instead included in the storage 340 without departing from the scope of the disclosure.

Note that controller VMs are provided as virtual machines utilizing hypervisors described herein—for example, the controller VM 308 is provided behind hypervisor 310. Since the controller VMs run “above” the hypervisors examples described herein may be implemented within any virtual machine architecture, since the controller VMs may be used in conjunction with generally any hypervisor from any virtualization vendor.

Virtual disks (vDisks) may be structured from the storage devices in storage 340, as described herein. A vDisk generally refers to the storage abstraction that may be exposed by a controller VM to be used by a user VM. In some examples, the vDisk may be exposed via iSCSI “internet small computer system interface”) or NFS (“network file system”) and may be mounted as a virtual disk on the user VM. For example, the controller VM 308 may expose one or more vDisks of the storage 340 and may mount a vDisk on one or more user VMs, such as user VM 304 and/or user VM 306.

During operation, user VMs (e.g., user VM 304 and/or user VM 306) may provide storage input/output (I/O) requests to controller VMs (e.g., controller VM 308 and/or hypervisor 310). Accordingly, a user VM may provide an I/O request to a controller VM as an iSCSI and/or NFS request. Internet Small Computer System Interface (iSCSI) generally refers to an IP-based storage networking standard for linking data storage facilities together. By carrying SCSI commands over IP networks, iSCSI can be used to facilitate data transfers over intranets and to manage storage over any suitable type of network or the Internet. The iSCSI protocol allows iSCSI initiators to send SCSI commands to iSCSI targets at remote locations over a network. In some examples, user VMs may send I/O requests to controller VMs in the form of NFS requests. Network File System (NFS) refers to an IP-based file access standard in which NFS clients send file-based requests to NFS servers via a proxy folder (directory) called “mount point”. Generally, then, examples of systems described herein may utilize an IP-based protocol (e.g., iSCSI and/or NFS) to communicate between hypervisors and controller VMs.

During operation, user VMs described herein may provide storage requests using an IP based protocol. The storage requests may designate the IP address for a controller VM from which the user VM desires I/O services. The storage request may be provided from the user VM to a virtual switch within a hypervisor to be routed to the correct destination. For examples, the user VM 304 may provide a storage request to hypervisor 310. The storage request may request I/O services from controller VM 308 and/or controller VM 318. If the request is to be intended to be handled by a controller VM in a same service node as the user VM (e.g., controller VM 308 in the same computing node as user VM 304) then the storage request may be internally routed within computing node 302 to the controller VM 308. In some examples, the storage request may be directed to a controller VM on another computing node. Accordingly, the hypervisor (e.g., hypervisor 310) may provide the storage request to a physical switch to be sent over a network (e.g., network 322) to another computing node running the requested controller VM (e.g., computing node 312 running controller VM 318).

Accordingly, controller VMs described herein may manage I/O requests between user VMs in a system and a storage pool. Controller VMs may virtualize I/O access to hardware resources within a storage pool according to examples described herein. In this manner, a separate and dedicated controller (e.g., controller VM) may be provided for each and every computing node within a virtualized computing system (e.g., a cluster of computing nodes that host hypervisor virtualization software), since each computing node may include its own controller VM. Each new computing node in the system may include a controller VM to share in the overall workload of the system to handle storage tasks. Therefore, examples described herein may be advantageously scalable, and may provide advantages over approaches that have a limited number of controllers. Consequently, examples described herein may provide a massively-parallel storage architecture that scales as and when hypervisor computing nodes are added to the system.

While virtual machines have been described with reference to figures herein, such as the user VMs 304, 306, 314, and/or 316 and/or the controller VMs 308 and 318 of FIG. 3, it is to be understood that in some examples, other compute units may be used to perform the functions described. For example, one or more containers may be used instead of and/or in addition to virtual machines described herein.

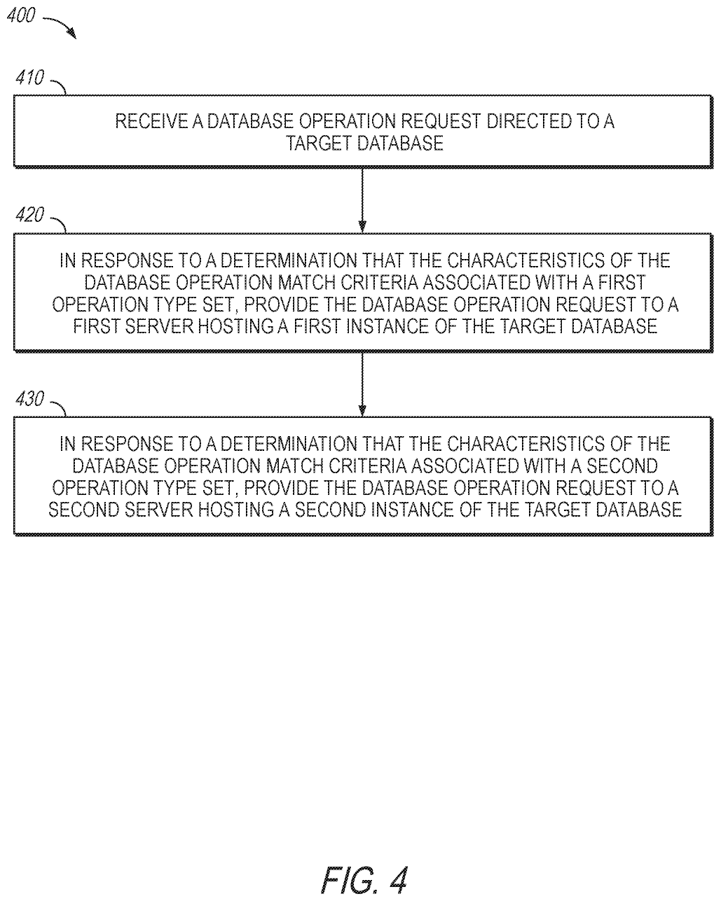

FIG. 4 is a flow diagram illustrating a method 400 for routing database operation requests, in accordance with an embodiment of the present disclosure. The method 400 may be performed using part or all of the computing system 100 of FIG. 1, the flow diagram 200 of FIG. 2, and/or the computing system 300 of FIG. 3.

The method 400 may include receiving a database operation request directed to a target database, at 410. The database operation request may be received at a database load balancer, such as the database load balancer 142 of FIG. 1, the database load balancer 242 of FIG. 2, and/or the database load balancer 319 of FIG. 3. The database load balancer may be included on a server, such as the server 140 or any of the computing node 112, the computing node 114, the computing node 116, the server 132, the server 134, or the server 136 of FIG. 1, any of the computing node 212, the computing node 214, the computing node 216, a server using the first database instance 233, a server using the second database instance 235, or a server using the third database instance 237 of FIG. 2, one of the computing nodes 302 or 312 of FIG. 3, or any combination thereof.

In some examples, the method 400 may further include determining whether characteristics of the database operation request match criteria associated with a first operation type set, and determining whether the characteristics of the database operation request match criteria associated with a second operation type. The first operation type set may be different than the second operation type set.

In some examples, the method 400 may include defining the first operation type set to include database operation requests directed to first data, a first database operation type, or combinations thereof, and defining the second operation type set to include database operation requests directed to second data, a second database operation type, or combinations thereof. In some examples, the first database operation type includes a first query and the second database operation type includes a second query. In some examples, the method 400 may further include re-defining the first operation type set to further include database operation requests directed to a third database operation type that is different than the first database operation type and the second database operation type. In some examples, the method 400 may further include, in response to increased frequency of the first database operation type, re-defining the first operation type set to exclude database operation requests directed to the third database operation type, and re-defining the second operation type set to further include database operation requests directed to the third database operation type. In some examples, the method 400 may further include, in response to a determination that the characteristics of the database operation request fail to match criteria associated with the first operation type set and the second operation type set, re-defining one of the first operation type set or the second operation type set to include criteria that includes characteristics of the database operation request.

The method 400 may further include, in response to a determination that characteristics of the database operation request match criteria associated with a first operation type set, providing (e.g., routing) the database operation request to a first server hosting a first instance of the target database, at 430. The method 400 may further include, in response to a determination that the characteristics of the database operation request match criteria associated with a second operation type set, providing the database operation request to a second server hosting a second instance of the target database, at 430. The first server and the second server may include any two of the server 132, the server 134, and the server 136 of FIG. 1, any two of the server using the first database instance 233, the server using the second database instance 235, or the server using the third database instance 237 of FIG. 2, or any two of a server using the first database instance 343, a server using the second database instance 345, or a server using the third database instance 347 of FIG. 3. The first and second instances may include any two of the first database instance 133, the second database instance 135, and the third database instance 137 of FIG. 1, any two of the first database instance 233, the second database instance 235, or the third database instance 237 of FIG. 2, or any two of the first database instance 343, the second database instance 345, or the third database instance 347 of FIG. 3. In some examples, the method 400 may further include, in response to a determination that the characteristics of the database operation request fail to match criteria associated with the first operation type set and the second operation type set, providing (e.g., routing) the database operation request to a third server using a third instance of the target database.

In some examples, the method 400 may further include receiving a second database operation request via the network, wherein the second database operation request is directed to the target database, and determining whether characteristics of the second database request operation match criteria associated with the first operation type set or the second operation type. In response to a determination that the characteristics of the second database operation request match criteria associated with the first operation type set, the second database operation request may be provided to the first server, and in response to a determination that the characteristics of the second database operation request match criteria associated with the second operation type set, the second database operation request may be provided to the second server.

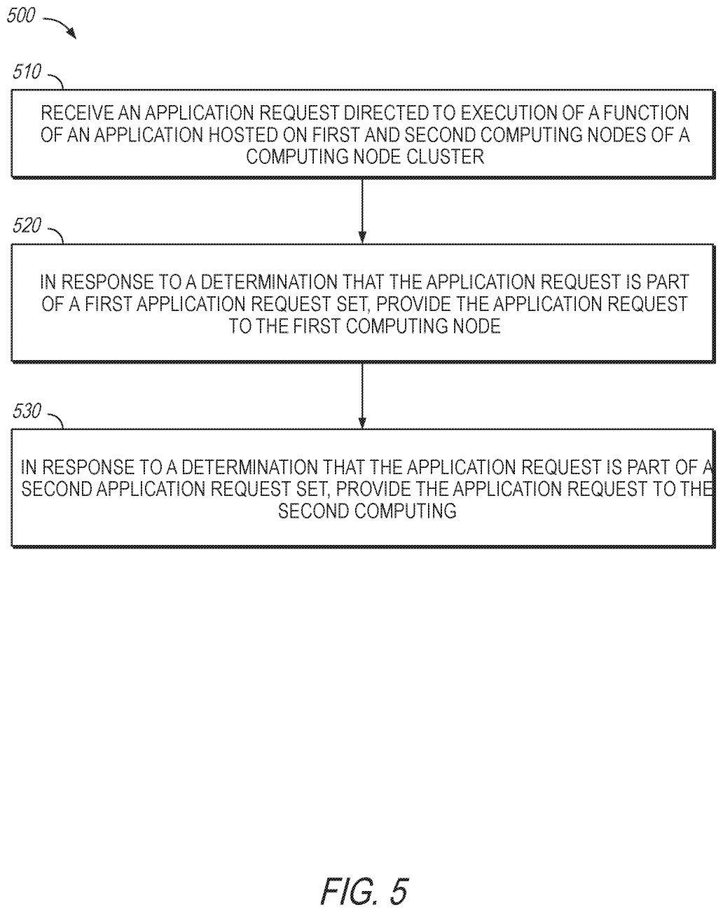

FIG. 5 is a flow diagram illustrating a method 500 for routing application requests in accordance with an embodiment of the present disclosure. The method 500 may be performed using part or all of the computing system 100 of FIG. 1, the computing system of FIG. 2, and/or the computing system 300 of FIG. 3.

The method 500 may include receiving an application request, at 510. The application request may be associated with execution of a function of an application hosted on a first computing node and a second computing node of a computing node cluster. The computing node cluster may include the computing node cluster 110 of FIG. 1. The first and second computing nodes may include the computing node 112, the computing node 114, and the computing node 116 of FIG. 1, the computing node 212, the computing node 214, and the computing node 216 of FIG. 2, the computing nodes 302 and 312 of FIG. 3, or combinations thereof. The application may include an application of the applications 113, the applications 115, and the applications 117 of FIG. 1, the applications 213, the applications 215, and the applications 217 of FIG. 2, applications hosted on any of the user VMs 304, 306, 314, and 316 of FIG. 3, or combinations thereof. The application request may be received at an application load balancer, such as the application load balancer 122 of FIG. 1, the application load balancer 222 of FIG. 2, or the application load balancer 309 of FIG. 3. The application load balancer may be included on a server, such as the server 120 or any of the computing node 112, the computing node 114, the computing node 116, the server 132, the server 134, or the server 136 of FIG. 1, any of the computing node 212, the computing node 214, or the computing node 216 of FIG. 2, one of the computing nodes 302 or 312 of FIG. 3, or any combination thereof.

The method 500 may further include determining whether the application request is part of a first application request set, and determining whether the application request is part of a second application request set. The first application request set may be different than the second application request set. In some examples, the first application request set may include at least some application requests directed to the application and the second application request set may include at least some application requests directed to a second application hosted on the first computing node and the second computing node.

In some examples, the method 500 may further include defining the first application request set to include at least some application requests directed to the application, and defining the second application request set to include at least some application requests directed to the application. In another example, the method 500 may further include defining the first application request set to include a first subset of application requests directed to a first application, and defining the second application request set to include a second subset of application requests directed to a second application. The first and second applications may include applications of the applications 113, the applications 115, and the applications 117 of FIG. 1, the applications 213, the applications 215, and the applications 217 of FIG. 2, applications hosted on any of the user VMs 304, 306, 314, and 316 of FIG. 3, or combinations thereof. In some examples, the method 500 may further include re-defining the first application request set to further include at least some application requests directed to a third application hosted on the first computing node and the second computing node. In other examples, the method 500 may further include, in response to increased frequency of the first subset of application requests, re-defining the first application request set to exclude the at least some application requests directed to the third application, and re-defining the second application request set to further include the at least sonic application requests directed to the third application. In some examples, the method 500 may further include, in response to a determination that the application request is excluded from the first application request set and the second application request set, re-defining one of the first application request set or the second application request set to include includes characteristic of the application request.

The method 500 may further include, in response to a determination that the application request is part of a first application request set, providing (e.g., routing) the application request to the first computing node, at 520, and in response to a determination that the application request is part of a second application request set, providing (e.g., routing) the application request to the second computing node, at 530. The first computing node and the second computing node may include any two of the computing node 112, the computing node 114, and the computing node 116 of FIG. 1, any two of the computing node 212, the computing node 214, and the computing node 216 of FIG. 2, or the computing nodes 302 and 312 of FIG. 3. In some examples, the method 500 may further include, in response to a determination that the application request is excluded from the first application request set and the second application request set, providing (e.g., routing) the application request to a third computing node of the computing node cluster configured to host the application.

In some examples, the method 500 may further include receiving a second application request directed to execution of a function associated with another application installed on each of the plurality of computing nodes, and determining whether the second application request is part of the first application request set or the second application request set. In response to a determination that the second application request is part of the first application request set, the second application request may be provided to the first computing node, and in response to a determination that the second application request is part of the second application request set, the second application request may be provided to the second computing node.

The methods 400 and 500 of FIGS. 4 and 5, respectively, and/or other software described herein with respect to at least FIGS. 1-3, may be implemented using executable (e.g., using one or more processing units) instructions encoded on one or more non-transitory computer readable media. The one or more processing units may include a central processing unit (CPU), a digital signal processor (DSP), a controller, another hardware device, a firmware device, or any combination thereof. The one or more non-transitory computer readable media may include a magnetic hard disk drive, a solid-state drive, a semiconductor storage device, a read-only memory (ROM), an erasable programmable read-only memory (EPROM), a flash memory, or any other computer-readable storage media that is capable of storing program instructions or digital information.

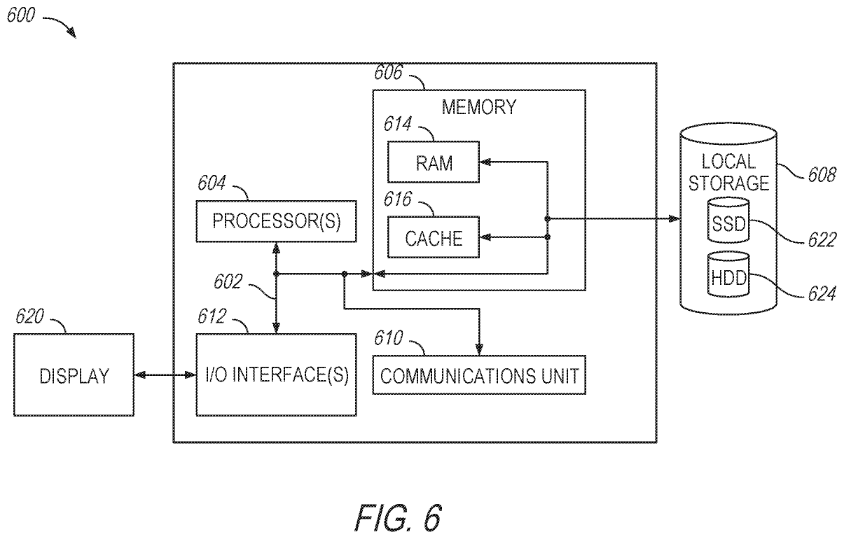

FIG. 6 depicts a block diagram of components of a computing node 600 in accordance with an embodiment of the present disclosure. It should be appreciated that FIG. 6 provides only an illustration of one implementation and does not imply any limitations with regard to the environments in which different embodiments may be implemented. Many modifications to the depicted environment may be made. The computing node 600 may implemented as any of the computing node 112, the computing node 114, the computing node 116, the server 120, the server 132, the server 134, or the server 136, or the server 140 of FIG. 1, any of the computing node 212, the computing node 214, or the computing node 216 of FIG. 2, the computing nodes 302 or 312 of FIG. 3, or any combination thereof. The computing node 600 may be configured to implement the method 400 of FIG. 4 to route database operation requests or the method 500 of FIG. 5 to route application requests.

The computing node 600 includes a communications fabric 602, which provides communications between one or more processor(s) 604, memory 606, local storage 608, communications unit 610, I/O interface(s) 612. The communications fabric 602 can be implemented with any architecture designed for passing data and/or control information between processors (such as microprocessors, communications and network processors, etc), system memory, peripheral devices, and any other hardware components within a system. For example, the communications fabric 602 can be implemented with one or more buses.

The memory 606 and the local storage 608 are computer-readable storage media. In this embodiment, the memory 606 includes random access memory RAM 614 and cache 616. In general, the memory 606 can include any suitable volatile or non-volatile computer-readable storage media. The local storage 608 may be implemented as described above with respect to local storage 340 of FIG. 3. In this embodiment, the local storage 608 includes an SSD 622 and an HDD 624, which may be implemented as described above with respect to SSD 326, SSD 332 and HDD 328, HDD 334 respectively.

Various computer instructions, programs, files, images, etc. may be stored in local storage 608 for execution by one or more of the respective processor(s) 604 via one or more memories of memory 606. In some examples, local storage 608 includes a magnetic HDD 624. Alternatively, or in addition to a magnetic hard disk drive, local storage 608 can include the SSD 622, a semiconductor storage device, a read-only memory (ROM), an erasable programmable read-only memory (EPROM), a flash memory, or any other computer-readable storage media that is capable of storing program instructions or digital information.

The media used by local storage 608 may also be removable. For example, a removable hard drive may be used for local storage 608. Other examples include optical and magnetic disks, thumb drives, and smart cards that are inserted into a drive for transfer onto another computer-readable storage medium that is also part of local storage 608.

Communications unit 610, in these examples, provides for communications with other data processing systems or devices. In these examples, communications unit 610 includes one or more network interface cards. Communications unit 610 may provide communications through the use of either or both physical and wireless communications links.

I/O interface(s) 612 allows for input and output of data with other devices that may be connected to computing node 600. For example, I/O interface(s) 612 may provide a connection to external device(s) 618 such as a keyboard, a keypad, a touch screen, and/or some other suitable input device. External device(s) 618 can also include portable computer-readable storage media. such as, for example, thumb drives, portable optical or magnetic disks, and memory cards. Software and data used to practice embodiments of the present disclosure can be stored on such portable computer-readable storage media and can be loaded onto local storage 608 via I/O interface(s) 612. I/O interface(s) 612 also connect to a display 620.

Display 620 provides a mechanism to display data to a user and may be, for example, a computer monitor.

Various features described herein may be implemented in hardware, software executed by a processor, firmware, or any combination thereof. If implemented in software (e.g., in the case of the methods described herein), the functions may be stored on or transmitted over as one or more instructions or code on a computer-readable medium. Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable read only memory (EEPROM), or optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor.

From the foregoing it will be appreciated that, although specific embodiments of the disclosure have been described herein for purposes of illustration, various modifications may be made without deviating from the spirit and scope of the disclosure. Accordingly, the disclosure is not limited except as by the appended claims.

What is claimed is:

1. A method comprising:
receiving a database operation request directed to a target database;
in response to a determination that characteristics of the database operation request match criteria associated with a first operation type set, providing the database operation request to a first server hosting a first instance of the target database; and
in response to a determination that the characteristics of the database operation request match criteria associated with a second operation type set, providing the database operation request to a second server hosting a second instance of the target database.

2. The method of claim 1, wherein the first operation type set includes database operation requests directed to first data, a first database operation type, or combinations thereof and the second operation type set includes database operation requests directed to second data, a second database operation type, or combinations thereof.

3. The method of claim 2, wherein the first database operation type includes a first query and the second database operation type includes a second query.

4. The method of claim 2, wherein the first operation type set further includes database operation requests directed to a third database operation type that is different than the first database operation type and the second database operation type.

5. The method of claim 4, further comprising in response to increased frequency of the first database operation type, re-defining the first operation type set to exclude database operation requests directed to the third database operation type and re-defining the second operation type set to further include database operation requests directed to the third database operation type.

6. The method of claim 1, further comprising, in response to a determination that a characteristics of a received second database operation request match criteria associated with the first operation type set, providing the received second database operation request to the first server.

7. The method of claim 6, further comprising, in response to a determination that the characteristics of the received second database operation request match criteria associated with the second operation type set, providing the received second database operation request to the second server.

8. The method of claim 1, further comprising, in response to a determination that the characteristics of the database operation request fail to match criteria associated with the first operation type set and the second operation type set, providing the database operation request to a third server using a third instance of the target database.

9. The method of claim 1, further comprising, in response to a determination that the characteristics of the database operation request fail to match criteria associated with the first operation type set and the second operation type set, re-defining one of the first operation type set or the second operation type set to include criteria that includes characteristics of the database operation request.

10. A method comprising:
receiving an application request, wherein the application request is associated with execution of a function of an application hosted on a first computing node and a second computing node of a computing node cluster;
in response to a determination that the application request is part of a first application request set, providing the application request to the first computing node; and
in response to a determination that the application request is part of a second application request set, providing the application request to the second computing node.

11. The method of claim 10, wherein the first application request set includes at least some application requests directed to the application and the second application request set includes at least some application requests directed to a second application hosted on the first computing node and the second computing node.

12. The method of claim 10, further comprising defining the first application request set to include a first subset of application requests directed to the application and the second application request set to include a second subset of application requests directed to the application.

13. The method of claim 12, further comprising re-defining the first application request set to further include at least some application requests directed to a second application hosted on the first computing node and the second computing node that is different than the application.

14. The method of claim 13, further comprising, in response to increased frequency of the first subset of application requests, re-defining the first application request set to exclude the at least some application requests directed to the second application and the second application request set to further include the at least some application requests directed to the second application.

15. The method of claim 10, further comprising, in response to a determination that a received second application request is part of the first application request set, providing the received second application request to the first computing node.

16. The method of claim 15, further comprising, in response to a determination that the received second application request is part of the second application request set, providing the received second application request to the second computing node.

17. The method of claim 10, further comprising, in response to a determination that the application request is excluded from the first application request set and the second application request set, providing the application request to a third computing node of the computing node cluster configured to host the application.

18. The method of claim 10, further comprising, in response to a determination that the application request is excluded from the first application request set and the second application request set, re-defining one of the first application request set or the second application request set to include includes characteristic of the application request.

19. At least one non-transitory computer-readable storage medium including instructions that when executed by a computing node in a computing system, causes the computing node to:
route database operation requests having criteria matching characteristics of a first database operation type set to a first database server hosting a first instance of the database; and
route database operation requests having criteria matching characteristics of a second database operation type set to a second database server hosting a second instance of the database.

20. The at least one computer-readable storage medium of claim 19, wherein the first database operation type includes a first query and the second database operation type includes a second query.

21. The at least one computer-readable storage medium of claim 20, wherein the instructions further cause the computing node to re-define the first operation type set to further include database operation requests directed to a third database operation type that is different than the first database operation type and the second database operation type.

22. The at least one computer-readable storage medium of claim 21, wherein the instructions further cause the computing node to, in response to increased frequency of the first database operation type, re-define the first operation type set to exclude database operation requests directed to the third database operation type and the second operation type set to further include database operation requests directed to the third database operation type.

23. At least one non-transitory computer-readable storage medium including instructions that when executed by a computing node in a computing system, causes the computing node to:
route application requests included in the first application request set to a first computing node of a computing node cluster; and
route application requests included in the second application request set to a second computing node of the computing node cluster.

24. The at least one computer-readable storage medium of claim 23, wherein the instructions further cause the computing node to define the first application request set to include a first subset of application requests directed to a first application and the second application request set to include a second subset of application requests directed to the first application.

25. The at least one computer-readable storage medium of claim 23, wherein the instructions further cause the computing node to re-define the first application request set to further include at least some application requests directed to a second application that is different than the first application.

26. The at least one computer-readable storage medium of claim 25, wherein the instructions further cause the computing node to, in response to increased frequency of the first subset of application requests, re-define the first application request set to exclude the at least some application requests directed to the third application and the second application request set to further include the at least some application requests directed to the third application.
